(19) United States
(12) Patent Application Publication
(10) Pub. No.: US 2026/0146591 A1
(43) Pub. Date: May 28, 2026

(54) COOLING SYSTEM FOR FLEXIBLE ACTUATOR BASED ON SHAPE MEMORY ALLOY AND OPERATION METHOD THEREOF

(71) Applicant: Electronics and Telecommunications Research Institute, Daejeon (KR)

(72) Inventors: Hanvit KIM, Daejeon (KR); Jeong Won PARK, Daejeon (KR); CHUL HUH, Daejeon (KR)

(21) Appl. No.: 19/380,774

(22) Filed: Nov. 5, 2025

(30) Foreign Application Priority Data
Nov. 28, 2024 (KR) 10-2024-0173368
Aug. 29, 2025 (KR) 10-2025-0121749

(51) Int. Cl. F03G 7/06; F03G 7/00

(52) U.S. Cl. CPC F03G 7/066; F03G 7/027; F03G 7/06145

(57) ABSTRACT

A method of cooling a flexible actuator including a coil spring and a plurality of silicone tubes includes providing cooling fluid to the plurality of silicone tubes based on a cooling signal, recovering cooling fluid from the plurality of silicone tubes and re-cooling the cooling fluid, and providing the re-cooled cooling fluid to the plurality of silicone tubes, wherein the flexible actuator is manufactured based on a shape memory alloy, and each of the plurality of silicone tubes is in contact with at least a portion of a plurality of outer circumferential surfaces of the coil spring.

### CROSS-REFERENCE TO RELATED APPLICATIONS

This application claims priority under 35 U.S.C. § 119 to Korean Patent Application No. 10-2024-0173368 filed on Nov. 28, 2024 and Korean Patent Application No. 10-2025-0121749 filed on Aug. 29, 2025, in the Korean Intellectual Property Office, the disclosure of which is incorporated by reference herein in their entirety.

### BACKGROUND

Embodiments of the present disclosure described herein relates to a cooling system, and more specifically, relate to a cooling system for a shape memory alloy-based flexible actuator and an operation method thereof.

A shape memory alloy may be an alloy capable of remembering a shape at a specific temperature. For example, the shape memory alloy may maintain a specific shape at a high temperature, and at low temperatures, may have a shape different from the shape at the high temperature. The shape memory alloy having such characteristics may be used to manufacture a flexible actuator.

A shape memory alloy-based flexible actuator requires rapid cooling for smooth operation. At present, as methods of cooling such the flexible actuator, a method of circulating cold air to the flexible actuator or a method of immersing or submerging the flexible actuator in a cooling fluid is employed. However, the above-described methods have a disadvantage of reducing flexibility of the flexible actuator.

### SUMMARY

Embodiments of the present disclosure provide a cooling system for a shape memory alloy-based flexible actuator having improved performance and an operation method thereof.

A method of cooling a flexible actuator comprising a coil spring and a plurality of silicone tubings according to an embodiment of the present disclosure comprises: providing a cooling fluid to the plurality of silicone tubings based on a cooling signal; recovering the cooling fluid from the plurality of silicone tubings and re-cooling the cooling fluid; and providing the re-cooled cooling fluid to the plurality of silicone tubings, wherein the flexible actuator includes a shape memory alloy, and wherein each of the plurality of silicone tubings contacts at least a portion of a plurality of outer circumferential surfaces of the coil spring.

In one embodiment, providing a cooling fluid to the plurality of silicone tubings based on the cooling signal includes performing a relaxation operation based on the cooling fluid.

In one embodiment, the method further comprises applying a current to the coil spring based on a heating signal.

In one embodiment, applying a current to the coil spring based on the heating signal comprises performing a contraction operation based on the current.

A cooling system according to an embodiment of the present disclosure comprises: a flexible actuator includes a shape memory alloy; and a cooling device configured to cool the flexible actuator, wherein the flexible actuator comprises: a coil spring; and a plurality of silicone tubes in contact with at least a portion of a plurality of outer circumferential surfaces of the coil spring and through which a cooling fluid flows, and wherein the cooling system is configured to provide the cooling fluid to the plurality of silicone tubes through the cooling device to control a temperature of the coil spring.

In one embodiment, the cooling system is further configured to recover the cooling fluid from the plurality of silicone tubings, re-cool the cooling fluid, and provide the re-cooled cooling fluid back to the plurality of silicone tubings.

In one embodiment, the cooling system is further configured to provide the cooling fluid to the plurality of silicone tubings based on a cooling signal.

In one embodiment, the cooling system further comprises a heating device, and the heating device is configured to supply current to the coil spring.

In one embodiment, the cooling system is further configured to supply current to the coil spring based on a heating signal.

In one embodiment, the cooling device further comprises a water pump configured to supply the cooling fluid to the plurality of silicone tubings.

In one embodiment, the cooling device further comprises a Peltier element.

In one embodiment, a first silicone tubing of the plurality of silicone tubings contacts a first outer peripheral surface of the plurality of outer peripheral surfaces of the coil spring, a second silicone tubing of the plurality of silicone tubings contacts a second outer peripheral surface of the plurality of outer peripheral surfaces of the coil spring that is opposite to the first outer peripheral surface, a third silicone tubing of the plurality of silicone tubings contacts the first outer peripheral surface, the second outer peripheral surface, and a third outer peripheral surface of the plurality of outer peripheral surfaces of the coil spring, and the third outer peripheral surface is an outer peripheral surface different from the first outer peripheral surface and the second outer peripheral surface.

In one embodiment, the shape memory alloy comprises at least one of nickel-titanium (Ni—Ti), nickel-titanium-copper (Ni—Ti—Cu), nickel-titanium-zirconium (Ni—Ti—Zr), nickel-titanium-hafnium (Ni—Ti—Hf), nickel-cobalt (Ni—Co), copper-aluminum-nickel (Cu—Al—Ni), copper-aluminum-beryllium (Cu—Al—Be), copper-zinc-aluminum (Cu—Zn—Al), copper-tin (Cu—Sn), iron-manganese-silicon (Fe—Mn—Si), iron-nickel-cobalt-titanium (Fe—Ni—Co—Ti), iron-chromium-nickel-silicon (Fe—Cr—Ni—Si), zinc-aluminum (Zn—Al), titanium-niobium (Ti—Nb), indium-titanium (In—Ti), and gold-cadmium (Au—Cd) alloys.

In one embodiment, the cooling system further comprises a controller configured to control the cooling device and the flexible actuator.

### BRIEF DESCRIPTION OF DRAWINGS

The above and other objects and features will be more apparent from the following description of embodiments, taken in conjunction with the accompanying drawings, in which:

FIG. 1 is a diagram illustrating a cooling system according to an embodiment of the present disclosure.

FIGS. 2A and 2B are diagrams illustrating an embodiment of a shape memory alloy-based flexible actuator.

FIG. 3 is a diagram illustrating an embodiment of the cooling system of FIG. 1.

FIG. 4 is a diagram illustrating one embodiment of an arrangement structure of a coil spring and silicone tubing.

FIGS. 5A, 5B, 5C, and 5D are diagrams for describing in more detail the arrangement structure of a coil spring and silicone tubing.

FIG. 6 is a flowchart illustrating an operation method of the cooling system of the present disclosure.

### DETAILED DESCRIPTION

Below, embodiments of the present disclosure will be described in detail and clearly to such an extent that an ordinary one in the art easily carries out the present disclosure.

As used herein, including in the claims, “or” as used in a list of items (e.g., a list of items prefaced by a phased such as “at least one of” or “one or more of” or “one or both of” indicates as inclusive list such that, for example, a list of at least one of A, B, or C means A or B or C or AB or AC or BC or ABC (i.e., A and B and C).

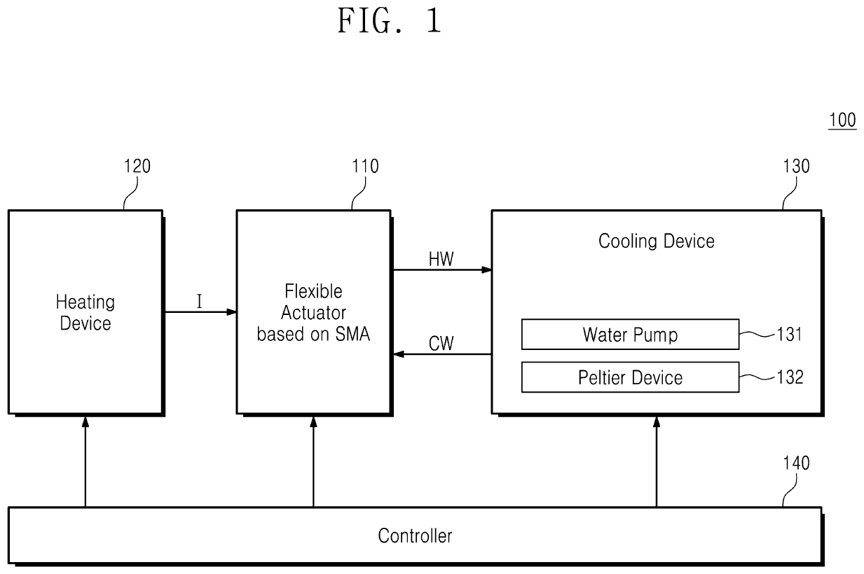

FIG. 1 is a drawing illustrating a cooling system according to an embodiment of the present disclosure. Referring to FIG. 1, the cooling system 100 may include a shape memory alloy (SMA)-based flexible actuator 110, a heating device 120, a cooling device 130, and a controller 140. The cooling system 100 may be a system configured to cool the shape memory alloy-based flexible actuator 110 which is heated by the heating device 120, through the cooling device 130. The shape memory alloy-based flexible actuator 110 may include a wearable robot, wearable clothing, a rehabilitation device, a healthcare device, a human assistive device, an artificial muscle, a prosthetic device such as an artificial arm or leg, a soft robot, a smart textile, an aerospace actuator, and/or the like, but the scope of the present disclosure is not limited thereto.

In one embodiment, the shape memory alloy-based flexible actuator 110 may be manufactured using a shape memory alloy. The shape memory alloy may include metallic material that exhibits a specific shape at a specific temperature. For example, the shape memory alloy may have a martensite phase in a low temperature state, and may have an austenite phase in a high temperature state. The shape memory alloy having the martensite phase may be easily deformed by external forces, whereas the shape memory alloy having the austenite phase may be restored to its original shape. For example, a shape memory alloy may be deformed at a low temperature by external forces, etc., and a deformed shape memory alloy may be restored to its original shape at a high temperature. The shape memory alloy-based flexible actuator 110 may be utilized for manufacturing artificial muscle that mimics a relaxation operation of contraction operation by using a shape change according to a temperature change. Alternatively, shape memory alloy-based flexible actuator 110 may be applied to various medical devices, such as wearable robots, rehabilitation devices, prosthetic devices, and/or the like.

In one embodiment, the shape memory alloy may include various alloys such as nickel-titanium (Ni—Ti), nickel-titanium-copper (Ni—Ti—Cu), nickel-titanium-zirconium (Ni—Ti—Zr), nickel-titanium-hafnium (Ni—Ti—Hf), nickel-cobalt (Ni—Co), copper-aluminum-nickel (Cu—Al—Ni), copper-aluminum-beryllium (Cu—Al—Be), copper-zinc-aluminum (Cu—Zn—Al), copper-tin (Cu—Sn), iron-manganese-silicon (Fe—Mn—Si), iron-nickel-cobalt-titanium (Fe—Ni—Co—Ti), iron-chromium-nickel-silicon (Fe—Cr—Ni—Si), zinc-aluminum (Zn—Al), titanium-niobium (Ti—Nb), indium-titanium (In—Ti), and gold-cadmium (Au—Cd), but the scope of the present disclosure is not limited thereto.

In the embodiment, the shape memory alloy-based flexible actuator 110 may perform a relaxation operation or a contraction operation based on the temperature change of the shape memory alloy. For example, the shape memory alloy-based flexible actuator 110 may perform the relaxation operation based on a temperature change from a high temperature to a low temperature. Alternatively, the shape memory alloy-based flexibility actuator 110 may perform the contraction operation based on the temperature change from a low temperature to a high temperature.

The heating device 120 may control the shape memory alloy-based flexible actuator 110 to be in a high temperature state. For example, the heating device 120 may control the shape memory alloy-based flexible actuator 110 to be in the high temperature state by applying current I to the shape memory alloy-based flexible actuator 110 to generate Joule heating. Joule heating may refer to heat generated in a resistance when a current flows through a conductor. When the shape memory alloy-based flexible actuator 110 is in a high temperature state through the heating device 120, the shape memory alloy-based flexible actuator 110 may undergo a phase transition from the martensite phase to an austenite phase. In the present disclosure, it is described that the heating device 120 control the shape memory alloy-based flexible actuator 110 to be in the high temperature state through joule heating, however, the scope of the present disclosure is not limited thereto. For example, the heating device 120 may control the shape memory alloy-based flexible actuator 110 to be in the high temperature state through a resistive heating element, a laser heating element, an infrared heater, a high frequency induction coil, and/or the like.

The cooling device 130 may include a water pump 131 and a Peltier device 132. In one embodiment, the cooling device 130 may control the shape memory alloy-based flexible actuator 110 to be in a low temperature state. For example, the cooling device 130 may supply a cooling water CW or a cooling fluid to the shape memory alloy-based flexible actuator 110 through the water pump 131. The cooling water CW or cooling fluid supplied to the shape memory alloy-based flexible actuator 110 may absorb heat from the shape memory alloy-based flexible actuator 110. The cooling water CW or cooling fluid absorbs heat from the shape memory alloy-based flexible actuator 110, thereby allowing the shape memory alloy-based flexible actuator 110 to be in the low temperature state. When the shape memory alloy-based flexible actuator 110 is in the low temperature state through the cooling device 130, the shape memory alloy-based flexible actuator 110 may undergo a phase transition from the austenite phase to the martensite phase.

In one embodiment, the cooling water CW or cooling fluid supplied to the shape memory alloy-based flexible actuator 110 may absorb heat from the heated shape memory alloy-based flexible actuator 110, and the hot water HW or heated fluid that has absorbed heat may be recovered to the cooling device 130. That is, the cooling water CW or cooling fluid supplied to the shape memory alloy-based flexible actuator 110 through the water pump 131 may be recovered back to the cooling device 130 after absorbing heat from the shape memory alloy-based flexible actuator 110.

The Peltier device 132 may be configured to re-cool the cooling water CW or hot water HW that has absorbed heat from the shape memory alloy-based flexible actuator 110. For example, the Peltier device 132 may be configured to absorb heat from the cooling water CW to cool it to a lower temperature, or to re-cool the hot water HW by absorbing heat from the hot water HW that has absorbed heat from the shape memory alloy-based flexible actuator 110.

The controller 140 may control overall operations of the cooling system 100. For example, the controller 140 may be a central processing unit (CPU) configured to control overall operations of the cooling system 100, but the scope of the present disclosure is not limited thereto.

In one embodiment, the controller 140 may control the cooling device 130 based on a cooling signal. The cooling signal may be a signal that causes the shape memory alloy-based flexible actuator 110 to perform a relaxation operation. The controller 140 may control the water pump 131 of the cooling device 130 to supply cooling water CW or a cooling fluid to the shape memory alloy-based flexible actuator 110 based on the cooling signal.

In one embodiment, the controller 140 may control the heating device 120 based on a heating signal. The heating signal may be a signal that causes the shape memory alloy-based flexible actuator 110 to perform a contraction operation. The controller 140 may control the heating device 120 to provide a current I to the shape memory alloy-based flexible actuator 110 based on the heating signal.

In the case of the conventional invention, in order to cool the heated shape memory alloy-based flexible actuator 110, a method of immersing or submerging the shape memory alloy-based flexible actuator 110 in cooling water of cooling fluid was used. However, in the case of the conventional invention, due to the specific heat of the cooling water or cooling fluid, when the cooled shape memory alloy-based flexible actuator is reheated, there is a problem in that the heating efficiency is reduced. Alternatively, since additional structures are required to submerge or immerse the shape memory alloy-based flexible actuator 110 in cooling water, there is a problem in that the weight of the shape memory alloy-based flexible actuator 110 is increased.

The cooling system 100 according to an embodiment of the present disclosure may cool the shape memory alloy-based flexible actuator 110 by supplying cooling water CW or a cooling fluid to the shape memory alloy-based flexible actuator 110 through silicone tubing that is in contact with at least a portion of a plurality of outer circumferential surfaces of the shape memory alloy-based flexible actuator 110 and through which fluid may flow. The silicone tubing, similar to capillaries, may contact with the entire surface of the shape memory alloy-based flexible actuator 110 evenly, thereby efficiently absorbing heat. According to the present disclosure, it is possible to reduce an increase in the weight of the shape memory alloy-based flexible actuator 110 and to improve cooling efficiency. In addition, when the cooled shape memory alloy-based flexible actuator 110 is heated, the heating efficiency may be improved.

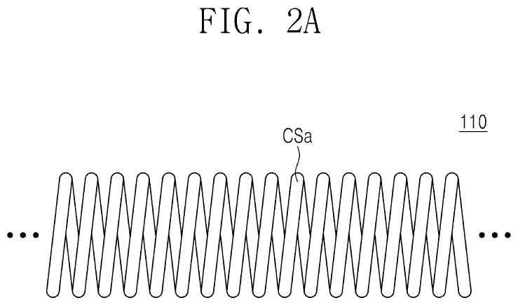

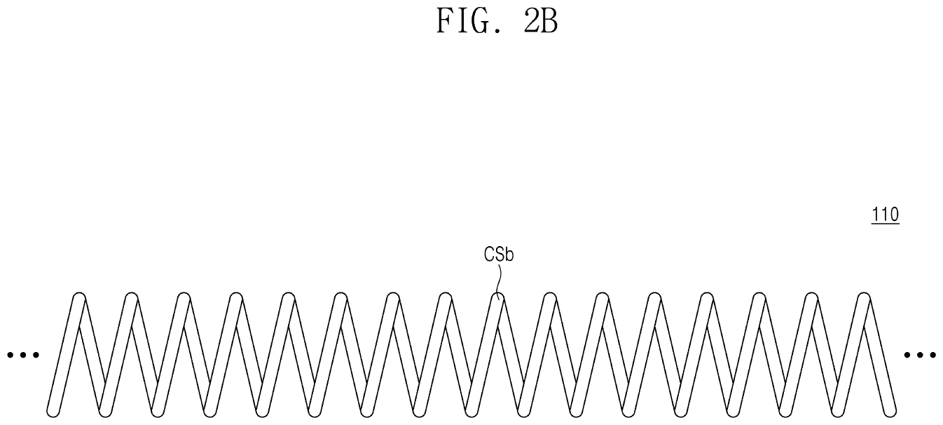

FIGS. 2A and 2B are diagrams illustrating an embodiment of a shape memory alloy-based flexible actuator. Referring to FIGS. 1, 2A, and 2B, the shape memory alloy-based flexible actuator 110 may include coil springs CSa and CSb. In the present disclosure, the shape memory alloy-based flexible actuator 110 is described as including coil springs CSa and CSb, but the scope of the present disclosure is not limited thereto. For example, the shape memory alloy-based flexible actuator 110 may include flexible actuators of various forms such as rod-type, wire-type, plate-type, spiral-type, and/or the like. Alternatively, the shape memory alloy-based flexible actuator 110 may include a flexible actuator manufactured using a combination of various shape memory alloys.

The coil springs CSa, CSb may be manufactured based on a shape memory alloy. The shape memory alloy may include a metallic material that changes shape according to temperature change. For example, the shape memory alloy may include a metallic material that has a martensite phase in a low temperature state and an austenite phase in a high temperature state. Hereinafter, the shape of the coil springs CSa, CSb according to the high temperature state or the low temperature state is described.

First, referring to FIG. 2A, the a-th coil spring CSa may be in a high temperature state. For example, the a-th coil spring CSa may be Joule heated by receiving current I from the heating device 120, and thus, may be in a high temperature state. The a-th coil spring CSa in the high temperature state may have an austenite phase. The a-th coil spring CSa having the austenite phase may have a contracted form compared to the b-th coil spring CSb having a martensite phase (e.g., the coil spring CSb of FIG. 2B).

Next, referring to FIG. 2B, the b-th coil spring CSb may be in a low temperature state. For example, the b-th coil spring CSb may be in a low temperature state by receiving cooling water CW or cooling fluid from the cooling device 130. The b-th coil spring CSb in the low temperature state may have a martensite phase. The b-th coil spring CSb having the martensite phase may have a relaxed form compared to the a-th coil spring CSa having an austenite phase (e.g., the first coil spring CSa of FIG. 2A).

In one embodiment, when the a-th coil spring CSa having an austenite phase is cooled by the cooling device 130, it may change its shape into the b-th coil spring CSb having a martensite phase (i.e., relaxation operation). Alternatively, when the b-th coil spring CSb having a martensite phase is heated by the heating device 120, it may change its shape into the a-th coil spring CSa having an austenite phase (i.e., contraction operation). The controller 140 may control the temperature of the shape memory alloy-based flexible actuator 110 by controlling the heating device 120 or the cooling device 130, and thus, the contraction operation or the relaxation operation may be performed.

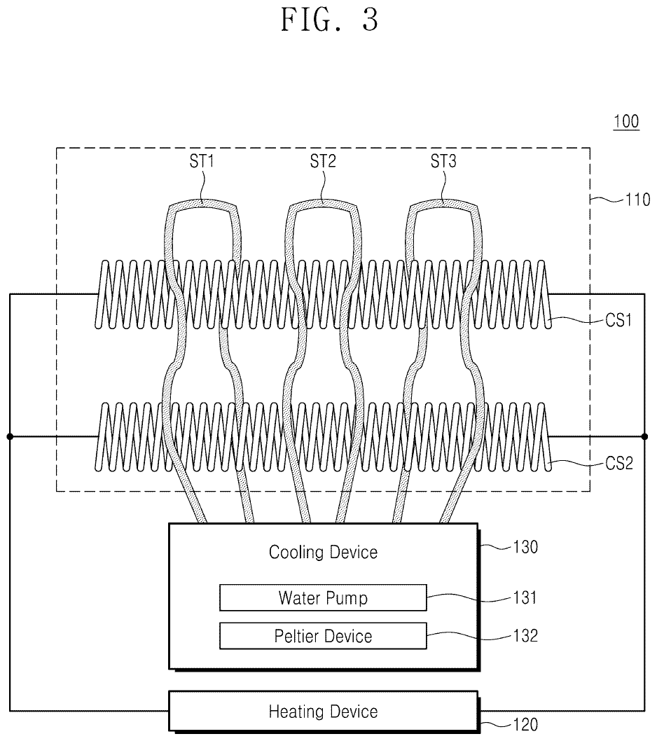

FIG. 3 is a diagram illustrating an embodiment of the cooling system of FIG. 1. Referring to FIGS. 1, 2, and 3, the cooling system 100 may include a shape memory alloy-based flexible actuator 110, a heating device 120, and a cooling device 130. The shape memory alloy-based flexible actuator 110 may include a plurality of coil springs CS1 to CS2 and a plurality of silicone tubings ST1 to ST3.

In one embodiment, the plurality of coil springs CS1 to CS2 may be electrically connected to the heating device 120. The plurality of coil springs CS1 to CS2 may be heated by receiving current from the heating device 120. When the plurality of coil springs CS1 to CS2 are heated to a high temperature state, the plurality of coil springs CS1 to CS2 may undergo a phase transition from a martensite phase to an austenite phase. That is, the plurality of coil springs CS1 to CS2 may contract.

In one embodiment, the plurality of silicone tubings ST1 to ST3 may have flow path through which cooling water or cooling fluid may flow. For example, the plurality of silicone tubings ST1 to ST3 may be connected to the cooling device 130, and the cooling water or cooling fluid supplied from the water pump 131 of the cooling device 130 may flow through the plurality of silicone tubings ST1 to ST3.

In one embodiment, the plurality of silicone tubings ST1 to ST3 may contact at least a portion of the plurality of outer circumferential surfaces of the plurality of coil springs CS1 to CS2. For example, each of the plurality of silicone tubings ST1 to ST3 may contact one outer circumferential surface among the plurality of outer circumferential surfaces of the plurality of coil springs CS1 to CS2. Alternatively, each of the plurality of silicone tubings ST1 to ST3 may contact two opposing outer circumferential surfaces among the plurality of outer circumferential surfaces of the plurality of coil springs CS1 to CS2. Alternatively, each of the plurality of silicone tubings ST1 to ST3 may contact at least three outer circumferential surfaces among the plurality of outer circumferential surfaces of the plurality of coil springs CS1 to CS2, thereby being arranged to wrap around the plurality of coil springs CS1 to CS2. That is, the plurality of silicone tubings ST1 to ST3 may have various arrangement configurations for closely contacting a portion of the surfaces of the plurality of coil springs CS1 to CS2. For example, the plurality of silicone tubings ST1 to ST3 may be arranged to continuously and selectively wrap around the outer circumferential surfaces of the plurality of coil springs CS1 to CS2 in a manner similar to how capillaries wrap around a blood vessel.

In one embodiment, the cooling water or cooling fluid may be supplied from the water pump 131 of the cooling device 130 to the plurality of silicone tubings ST1 to ST3. When the supplied cooling water flows through the plurality of silicone tubings ST1 to ST3, the temperature of the heated plurality of coil springs CS1 to CS2 may decrease. For example, as the plurality of silicone tubings ST1 to ST3 are in close contact with portions of the surfaces of the plurality of coil springs CS1 to CS2, the cooling water or cooling fluid flowing through the plurality of silicone tubings ST1 to ST3 may absorb heat from the plurality of coil springs CS1 to CS2. Due to the cooling water absorbing heat, the plurality of silicone tubings ST1 to ST3 may be in a low temperature state. When the plurality of silicone tubings ST1 to ST3 is in the low temperature state, the plurality of coil springs CS1 to CS2 may change in form from an austenite phase to a martensite phase. That is, the plurality of coil springs CS1 to CS2 may be relaxed.

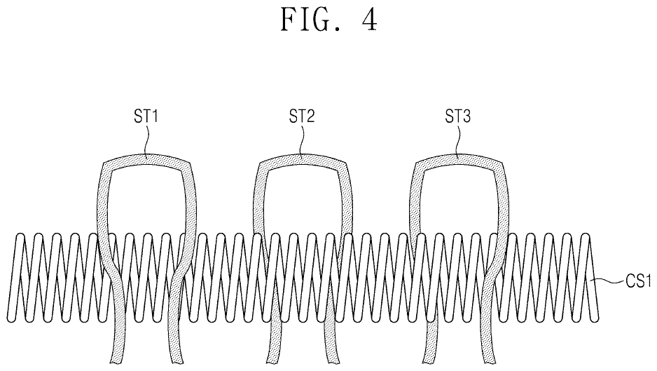

FIG. 4 is a diagram illustrating one embodiment of an arrangement structure of a coil spring and silicone tubing.

Referring to FIGS. 1, 2, 3, and 4, first to third silicone tubings ST1 to ST3 and a first coil spring CS1 are illustrated.

The first silicone tubing ST1 may contact a first outer circumferential surface among a plurality of outer circumferential surfaces of the first coil spring CS1. The second silicone tubing ST2 may contact a second outer circumferential surface opposing the first outer circumferential surface among the plurality of outer circumferential surfaces. The third silicone tubing ST3 may contact both the first outer circumferential surface and the second outer circumferential surface simultaneously. However, the scope of the present disclosure is not limited thereto, and the arrangement of the silicone tubings and the coil spring may vary. For example, the silicone tubing may contact a third outer circumferential surface different from the first outer circumferential surface and the second outer circumferential surface, or may contact all of the first outer circumferential surface, the second outer circumferential surface, and the third outer circumferential surface. Alternatively, the silicone tubing may contact at least three or more outer circumferential surfaces to surround the coil spring. That is, the plurality of silicone tubings ST1 to ST3 may be arranged to continuously and selectively surround the outer circumferential surface of the coil spring CS1 in a manner similar to how capillaries surround a blood vessel.

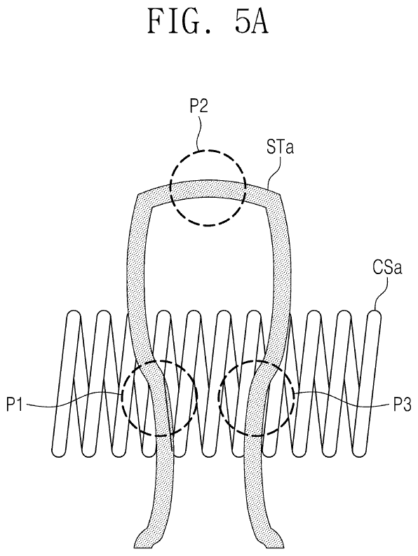

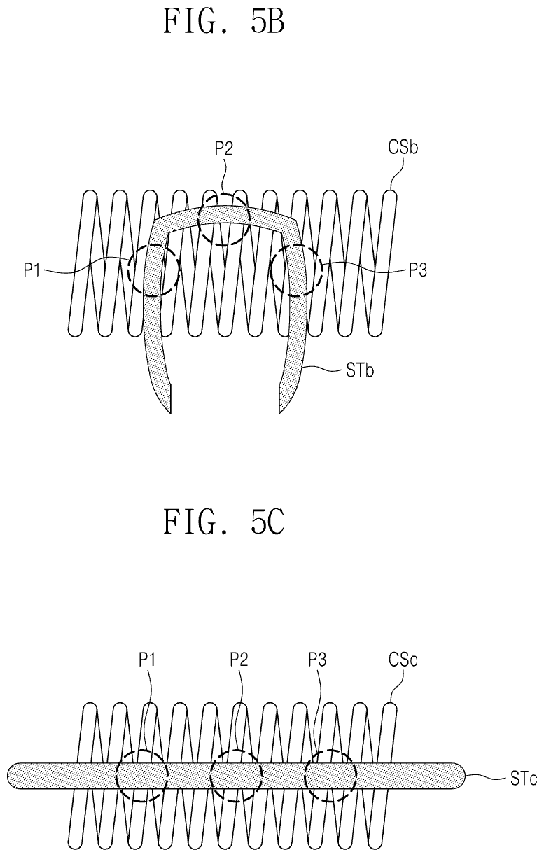

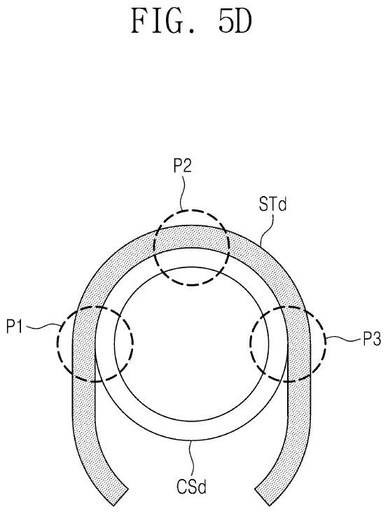

FIGS. 5A, 5B, 5C, and 5D are drawings for describing in more detail the arrangement structure of the coil spring and the silicone tubing.

First, referring to FIG. 5A, an a-th coil spring CSa and an a-th silicone tubing STa are illustrated. The a-th coil spring CSa may be manufactured based on a shape memory alloy. The a-th silicone tubing STa may include a flow path through which cooling water or cooling fluid may flow. For example, the cooling water or cooling fluid may flow from a first point P1 to a third point P3 via a second point P2 through the flow path of the a-th silicone tubing STa. Alternatively, the cooling water or cooling fluid may flow from the third point P3 to the first point P1 via the second point P2 through the flow path of the a-th silicone tubing STa.

In one embodiment, the a-th silicone tubing STa may have a curved structure. Accordingly, the direction of the cooling fluid flowing at the first point P1 of the a-th silicone tubing STa and the direction of the cooling fluid flowing at the third point P3 may be opposite to each other. Alternatively, the direction of the cooling fluid flowing at the second point P2 of the a-th silicone tubing STa may not be parallel to the direction of the cooling fluid flowing at the first point P1 or the third point P3 (e.g., the directions may be perpendicular to each other).

In one embodiment, the a-th silicone tubing STa may contact one of the plurality of outer circumferential surfaces of the a-th coil spring CSa. For example, the a-th silicone tubing STa may contact one of the plurality of outer circumferential surfaces of the a-th coil spring CSa at the first point P1 and the third point P3. The a-th silicone tubing STa may be in close contact with the a-th coil spring CSa at the first point P1 and the third point P3. When the cooling water or cooling fluid flows through the a-th silicone tubing STa, the cooling water or cooling fluid may absorb heat from the a-th coil spring CSa at the first point P1 and the third point P3.

Next, referring to FIG. 5B, a b-th coil spring CSb and a b-th silicone tubing STb are illustrated. The b-th coil spring CSb may be manufactured based on a shape memory alloy. The b-th silicone tubing STb may include a flow path through which cooling water or cooling fluid may flow. For example, the cooling water or cooling fluid may flow from the first point P1 to the third point P3 via the second point P2 through the flow path of the b-th silicone tubing STb. Alternatively, the cooling water or cooling fluid may flow from the third point P3 to the first point P1 via the second point P2 through the flow path of the b-th silicone tubing STb. The b-th silicone tubing STb may have a curved structure.

In one embodiment, the b-th silicone tubing STb may contact one among a plurality of outer circumferential surfaces of the b-th coil spring CSb. For example, the b-th silicone tubing STb may contact one among the plurality of outer circumferential surfaces of the b-th coil spring CSb through the first point P1, the second point P2, and the third point P3. The b-th silicone tubing STb may be in close contact with the b-th coil spring CSb at the first point P1, the second point P2, and the third point P3. When the cooling water or cooling fluid flows through the b-th silicone tubing STb, the cooling water or cooling fluid may absorb heat from the b-th coil spring CSb at the first point P1, the second point P2, and the third point P3. The b-th silicone tubing STb of FIG. 5B may contact the b-th coil spring CSb at the second point P2 which is different from the a-th silicone tubing STa of FIG. 5a.

Next, referring to FIG. 5C, a c-th coil spring CSc and a c-th silicone tubing STc are illustrated. The c-th coil spring CSc may be manufactured based on a shape memory alloy. The c-th silicone tubing STc may include a flow path through which cooling water or cooling fluid may flow. For example, the cooling water or cooling fluid may flow from the first point P1 to the third point P3 via the second point P2 through the flow path of the c-th silicone tubing STc. Alternatively, the cooling water or cooling fluid may flow from the third point P3 to the first point P1 via the second point P2 through the flow path of the c-th silicone tubing STc.

In one embodiment, the c-th silicone tubing STc may have a linear structure. Accordingly, the directions of the cooling fluid flowing at each of the first point P1, second point P2, and third point P3 of the c-th silicone tubing STc may be the same.

In one embodiment, the c-th silicone tubing STc may contact one among a plurality of outer circumferential surfaces of the c-th coil spring CSc. For example, the c-th silicone tubing STc may contact one among the plurality of outer circumferential surfaces of the c-th coil spring CSc through the first point P1, the second point P2, and the third point P3. The c-th silicone tubing STc may be in close contact with the c-th coil spring CSc at the first point P1, the second point P2, and the third point P3. When the cooling water or cooling fluid flows through the c-th silicone tubing STc, the cooling water or cooling fluid may absorb heat from the c-th coil spring CSc at the first point P1, the second point P2, and the third point P3. The c-th silicone tubing STc of FIG. 5C may be arranged to extend in the same direction as the extending direction of the c-th coil spring CSc.

Finally, referring to FIG. 5D, a d-th coil spring CSd and a d-th silicone tubing STd are illustrated. The d-th coil spring CSd may be manufactured based on a shape memory alloy. The d-th silicone tubing STd may include a flow path through which cooling water or cooling fluid may flow. For example, the cooling water or cooling fluid may flow from the first point P1 to the third point P3 via the second point P2 through the flow path of the d-th silicone tubing STd. Alternatively, the cooling water or cooling fluid may flow through the flow path of the d-th silicone tubing STd from the third point P3 to the first point P1 via the second point P2. The d-th silicone tubing STd may have a curved structure.

In one embodiment, the d-th silicone tubing STd may contact at least a portion of the plurality of outer circumferential surfaces of the d-th coil spring CSd. For example, the d-th silicone tubing STd may contact at least a portion of the plurality of outer circumferential surfaces of the d-th coil spring CSd through a first point P1, a second point P2, and a third point P3. The d-th silicone tubing STd may be in close contact with the d-th coil spring CSd at the first point P1, the second point P2, and the third point P3. When the cooling water or cooling fluid flows through the d-th silicone tubing STd, the cooling water or cooling fluid may absorb heat from the d-th coil spring CSd at the first point P1, the second point P2, and the third point P3.

The d-th silicone tubing STd may be arranged to cover the d-th coil spring CSd. For example, while the a-th to c-th silicone tubings STa to STc may be arranged to contact and closely adhere to one among the plurality of outer circumferential surfaces of the coil spring, the d-th silicone tubing STd may be arranged to surround at least a portion of the plurality of outer circumferential surfaces of the d-th coil spring CSd.

According to an embodiment of the present disclosure, a plurality of silicone tubings may contact at least a portion of the plurality of outer circumferential surfaces of the shape memory alloy-based flexible actuator, and when cooling water flows through the plurality of silicone tubings, the cooling water may absorb heat from the flexible actuator, thereby allowing the flexible actuator to be in a low temperature state. Accordingly, the flexible actuator may perform a relaxation operation.

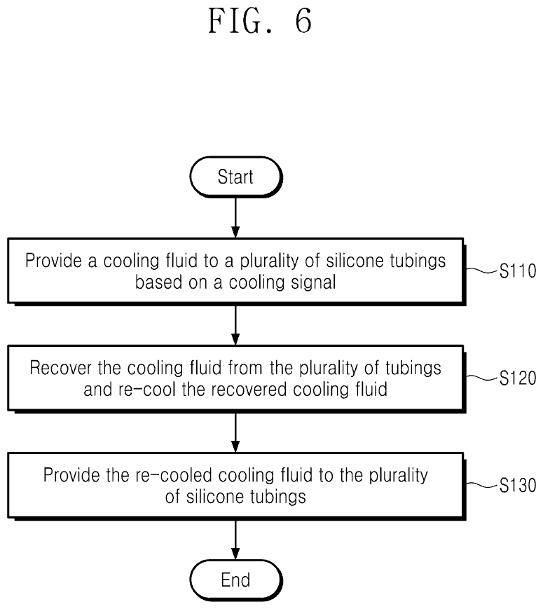

FIG. 6 is a flowchart illustrating an operation method of the cooling system of the present disclosure.

Referring to FIGS. 1 to 6, in step S110, the cooling system 100 may supply a cooling fluid to a plurality of silicone tubings ST1 to ST3 based on a cooling signal. The cooling signal may be a signal for performing a relaxation operation. For example, the water pump 131 of the cooling device 130 may supply the cooling fluid to the plurality of silicone tubings ST1 to ST3 based on the cooling signal. The processor 140 may control the water pump 131 of the cooling device 130 to supply the cooling fluid to the plurality of silicone tubings ST1 to ST3 based on the cooling signal.

In step S120, the cooling system 100 may recover the cooling fluid from the plurality of silicone tubings ST1 to ST3 and re-cool the cooling fluid. For example, the cooling fluid supplied to the plurality of silicone tubings ST1 to ST3 may absorb heat from the plurality of coil springs CS1 to CS2, and the cooling system 100 may recover the heat-absorbed cooling fluid to the cooling device 130. The cooling system 100 may re-cool the recovered cooling fluid through the Peltier device 132.

In step S130, the cooling system 100 may supply the re-cooled cooling fluid to the plurality of silicone tubings ST1 to ST3. For example, the water pump 131 of the cooling device 130 may supply the re-cooled cooling fluid to the plurality of silicone tubings ST1 to ST3. That is, the cooling fluid may be supplied to the plurality of silicone tubings ST1 to ST3 to absorb heat from the plurality of coil springs CS1 to CS2, and may repeat the operation of being re-cooled by the cooling device 130. By repeating the above-described operation, the cooling system 100 according to an embodiment of the present disclosure may reduce the temperature of the shape memory alloy-based flexible actuator 110.

The cooling system according to an embodiment of the present disclosure may cool the shape memory alloy-based flexible actuator by supplying cooling water or a cooling fluid through silicone tubing, which contacts at least a portion of the plurality of outer circumferential surfaces of the shape memory alloy-based flexible actuator and through which fluid may flow. According to an embodiment of the present disclosure, the silicone tubing may contact the entire surface of the shape memory alloy-based flexible actuator evenly, similar to capillaries, thereby efficiently absorbing heat. In this way, the weight increase of the shape memory alloy-based flexible actuator 110 may be reduced, and cooling efficiency may be improved. In addition, when the cooled shape memory alloy-based flexible actuator 110 is heated, heating efficiency may also be improved.

The foregoing description includes specific embodiments for implementing the present disclosure. The present disclosure will include not only the above-described embodiments, but also embodiments that are simply modified in design or that may be easily changed. In addition, the present disclosure will also include technologies that may be easily modified and implemented using the embodiments. Therefore, the scope of the present disclosure should not be limited to the above-described embodiments, but should be determined by the claims set forth below as well as equivalents to the claims of the present disclosure.

What is claimed is:

1. A method of cooling a flexible actuator including a coil spring and a plurality of silicone tubings, the method comprising:
providing a cooling fluid to the plurality of silicone tubings based on a cooling signal;
recovering the cooling fluid from the plurality of silicone tubings and re-cooling the cooling fluid; and
providing the re-cooled cooling fluid to the plurality of silicone tubings,
wherein the flexible actuator includes a shape memory alloy, and
wherein each of the plurality of silicone tubings is in contact with at least a portion of a plurality of outer circumferential surfaces of the coil spring.

2. The method of claim 1, wherein the providing the cooling fluid to the plurality of silicone tubings based on the cooling signal includes performing a relaxation operation based on the cooling fluid.

3. The method of claim 1, further comprising:
applying a current to the coil spring based on a heating signal.

4. The method of claim 3, the applying the current to the coil spring based on the heating signal includes performing a contraction operation based on the current.

5. A cooling system, comprising:
a flexible actuator includes a shape memory alloy; and
a cooling device configured to cool the flexible actuator,
wherein the flexible actuator comprising:
a coil spring; and
a plurality of silicone tubings in contact with at least a portion of a plurality of outer circumferential surfaces of the coil spring, through which a cooling fluid flows,
wherein the cooling system is configured to provide the cooling fluid to the plurality of silicone tubings through the cooling device to control a temperature of the coil spring.

6. The cooling system of claim 5, further configured to:
recover the cooling fluid from the plurality of silicone tubings,
re-cool the recovered cooling fluid, and
provide the re-cooled cooling fluid to the plurality of silicone tubings.

7. The cooling system of claim 5, further configured to provide the cooling fluid to the plurality of silicone tubings based on a cooling signal.

8. The cooling system of claim 5, further comprising a heating device,
wherein the heating device is configured to supply a current to the coil spring.

9. The cooling system of claim 8, further configured to supply the current to the coil spring based on a heating signal.

10. The cooling system of claim 5, wherein the cooling device further includes a water pump configured to supply the cooling fluid to the plurality of silicones tubings.

11. The cooling system of claim 5, wherein the cooling device further includes a Peltier device.

12. The cooling system of claim 5, wherein a first silicone tubing among of the plurality of silicones tubings is in contact with a first outer circumferential surface of the plurality of outer circumferential surfaces of the coil spring,
wherein a second silicone tubing among of the plurality of silicones tubings is in contact with a second outer circumferential surface of the plurality of outer circumferential surfaces of the coil spring, the second outer circumferential surface being opposite to the first outer circumferential surface, and
wherein a third silicone tubing among of the plurality of silicones tubings is in contact with the first outer circumferential surface, the second outer circumferential surface, and a third outer circumferential surface of the plurality of outer circumferential surfaces of the coil spring, the third outer circumferential surface being different from the first outer circumferential surface and the second outer circumferential surface.

13. The cooling system of claim 5, wherein the shape memory alloy includes at least one of nickel-titanium (Ni—Ti), nickel-titanium-copper (Ni—Ti—Co), nickel-titanium-zirconium (Ni—Ti—Zr), nickel-titanium-hafnium (Ni—Ti—Hf), nickel-cobalt (Ni—Co), copper-aluminum-nickel (Co—Al—Ni), copper-aluminum-beryllium (Co—Al—Be), copper-zinc-aluminum (Co—Zn—Al), copper-tin (Co—Sn), iron-nickel-cobalt-titanium (Fe—Ni—Co—Ti), iron-chromium-nickel-silicon (Fe—Cr—Ni—Si), zinc-aluminum (Zn—Al), titanium-niobium (Ti—Nb), indium-titanium (In—Ti), and/or gold-cadmium (Au—Cd) alloys.

14. The cooling system of claim 5, further comprising a controller configured to control the cooling device and the flexible actuator.
